(19) United States
(12) Patent Application Publication
(10) Pub. No.: US 2024/0146532 A1
(43) Pub. Date: May 2, 2024

(54) SYSTEMS AND METHODS FOR AUTONOMOUSLY GENERATING AND MAINTAINING NON-FUNGIBLE TOKENS FOR REAL-TIME SUBJECT ASSESSMENT

(71) Applicant: State Farm Mutual Automobile Insurance Company, Bloomington, IL (US)

(72) Inventors: Seth L. Corin, Cumming, GA (US); Aaron Williams, Congerville, IL (US)

(21) Appl. No.: 18/496,158

(22) Filed: Oct. 27, 2023

Related U.S. Application Data
(60) Provisional application No. 63/421,723, filed on Nov. 2, 2022.
(60) Provisional application No. 63/589,785, filed on Oct. 12, 2023.

(51) Int. Cl. H04L 9/32; H04L 9/00

(52) U.S. Cl. CPC H04L 9/3213; H04L 9/50

(57) ABSTRACT

A computer system for generating and maintaining non-fungible tokens for real-time subject assessment is described herein. The computer system includes at least one processor in communication with at least one memory device, the at least one processor programmed to: (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and (vi) input the plurality of data to a trained model to receive an initial subject assessment as output from the trained model.

### CROSS-REFERENCE TO RELATED APPLICATIONS

The present application claims the benefit of priority to U.S. Provisional Patent Application No. 63/421723, filed on Nov. 2, 2022, and to U.S. Provisional Patent Application No. 63/589785, filed Oct. 12, 2023, the entire contents of each of which are hereby incorporated by reference herein.

### FIELD OF THE DISCLOSURE

The present disclosure relates to generating and maintaining non-fungible tokens (NFTs) and, more particularly, to network-based systems and methods for autonomously generating and maintaining NFTs for real-time subject and object assessment.

### BACKGROUND

There are many situations in which assessing and evaluating an object's history or a subject's history is useful or necessary. For example, when selling, purchasing, leasing, or insuring an object, it may be beneficial to have an accurate and complete history of the object, to improve any assessment or evaluation of that object. However, in many instances, an object's known history may be limited, and frequently out of date. In further instances, certain aspects of an object's history may be difficult to discern and/or monitor. As another example, when evaluating a subject's recorded vehicle usage history, such a history may not accurately reflect the subject's driving behavior.

Accordingly, it would be useful to have a system for securely collecting, storing, and updating information relating to objects and subjects and providing access to that information as needed. The systems and methods disclosed herein may also provide solutions to the ineffectiveness, insecurities, difficulties, inefficiencies, encumbrances, and/or other drawbacks of conventional techniques.

### BRIEF SUMMARY

The present embodiments may relate to systems and methods for providing enhanced subject and object assessment using automated NFT generating and maintenance. A computer system, as described herein, may include a token management (TM) computer device that is in networked communication with a plurality of remote data sources, including data storage devices and sensors. The TM computer device may be configured to: (a) receive a plurality of data associated with an object history of an object; (b) generate a container file for the object history to include the plurality of data; (c) generate a non-fungible token (NFT) for the object based upon the container file; (d) store the NFT and the container file for the object; (e) retrieve the NFT to access the plurality of data; and/or (f) input the plurality of data to a trained model to receive an initial object assessment as output from the trained model.

The TM computer device may additionally be configured to: (a) receive a plurality of data associated with a subject history of a subject; (b) generate a container file for the subject history to include the plurality of data; (c) generate a non-fungible token (NFT) for the subject based upon the container file; (d) store the NFT and the container file for the subject; (e) retrieve the NFT to access the plurality of data; and/or (f) input the plurality of data to a trained model to receive an initial subject assessment as output from the trained model.

In one aspect, a computer system for providing enhanced object assessment using automated NFT generation and maintenance is described. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may include at least one processor in communication with at least one memory device. The at least one processor may be programmed to: (i) receive a plurality of data associated with an object history of an object; (ii) generate a container file for the object history to include the plurality of data; (iii) generate a non-fungible token (NFT) for the object based upon the container file; (iv) store the NFT and the container file for the object; (v) retrieve the NFT to access the plurality of data; and/or (vi) input the plurality of data to a trained model to receive an initial object assessment as output from the trained model. The computer system may have additional, less, or alternate functionality, including that discussed elsewhere herein. Methods and programs (e.g., at least one non-transitory computer-readable storage media having computer-executable instructions embodied thereon) for implementing the same may also be provided.

For instance, a computer-implemented method may provide enhanced object assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (1) receiving, via one or more processors and/or associated transceivers, a plurality of data associated with an object history of an object; (2) generating, via the one or more processors, a container file for the object history to include the plurality of data; (3) generating, via the one or more processors, a non-fungible token (NFT) for the object based upon the container file; (4) storing, via the one or more processors, the NFT and the container file for the object; (5) retrieving, via the one or more processors, the NFT to access the plurality of data; and/or (6) inputting, via the one or more processors, the plurality of data to a trained model to receive an initial object assessment as output from the trained model. The method may include additional, less, or alternate actions, including those discussed elsewhere herein.

In another aspect, a computer system for providing enhanced subject assessment using automated NFT generation and maintenance is described. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may include at least one processor in communication with at least one memory device. The at least one processor may be programmed to: (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and/or (vi) input the plurality of data to a trained model to receive an initial subject assessment as output from the trained model. The computer system may have additional, less, or alternate functionality, including that discussed elsewhere herein. Methods and programs (e.g., at least one non-transitory computer-readable storage media having computer-executable instructions embodied thereon) for implementing the same may also be provided.

In some aspects, a computer-implemented or computer-based method for providing enhanced subject assessment using automated NFT generating and maintenance may be implemented by a computing device, such as the TM computing device. The method may include (a) receiving a plurality of data associated with a subject history of a subject; (b) generating a container file for the subject history to include the plurality of data; (c) generating a non-fungible token (NFT) for the subject based upon the container file; (d) storing the NFT and the container file for the subject; (e) retrieving the NFT to access the plurality of data; and/or (f) inputting the plurality of data to a trained model to receive an initial subject assessment as output from the trained model.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process for generating and maintaining NFTs related to object histories and assessments in accordance with one embodiment of this disclosure;

FIG. 2 illustrates a simplified block diagram of an exemplary computer system for implementing the processes shown in FIG. 1 and FIG. 6;

FIG. 3 illustrates a flow chart of an exemplary computer-implemented process for generating and maintaining NFTs related to object histories and assessments, using the system shown in FIG. 2;

FIG. 4 illustrates an exemplary configuration of a client computer device shown in FIG. 2, in accordance with one embodiment of the present disclosure;

FIG. 5 illustrates an exemplary configuration of a server shown in FIG. 2, in accordance with one embodiment of the present disclosure;

FIG. 6 illustrates a flow chart of an exemplary process for generating and maintaining NFTs related to subject histories and assessments in accordance with one embodiment of this disclosure; and

FIG. 7 illustrates a flow chart of an exemplary computer-implemented process for generating and maintaining NFTs related to subject histories and assessments, which may include object histories and assessments, using the system shown in FIG. 2.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for generating and maintaining NFTs and, more particularly, to network-based systems and methods for autonomously generating and maintaining NFTs for real-time object and subject evaluation. A computer system, as described herein, may include a token management (TM) computing device (also referred to as a “TM server”) that is in communication with a plurality of data sources or third-party device, a plurality of sensors, and one or more user computing devices.

As used herein, “objects” may include personal property, vehicles, homes, and/or other buildings. In at least some embodiments, “objects” may broadly encompass any item or property that would be assessed during the purchase, sale, or insuring of the item. As used herein, “subjects” may include objects as well as persons or groups thereof. Such persons may include, for example, users or owners of objects, including (but not limited to) property owners, property occupants, tenants, vehicle owners, vehicle users/renters/lessees, persons using ride-share applications as drivers and/or passengers, users/renters of other personal mobility vehicles (e.g., bicycles, scooters), users or owners of insured objects (e.g., jewelry, art), and the like. Accordingly, where reference is made to a “subject,” such reference may also encompass an “object.” Although reference to both subject(s) and object(s) may be made herein, such reference is made for purposes of clarity and explanation and should not be construed as limiting.

Assessing objects may be performed in the course of buying, selling, leasing, and/or insuring an object. It may be generally known to perform an assessment of an object based upon static history data elements. For example, in the case of insuring a vehicle, an insurance policy may be developed based upon an associated driving record, vehicle characteristics, location, and the like. As another example, to insure a home or other property, the insurance policy may be developed based upon credit score, location of home, age of home, and the like. Assessing subjects may also occur at various times, including when a subject is buying, selling, leasing/renting, using, and/or insuring an object, starting a new job, and/or experiencing other significant life events. It may be generally known to perform an assessment of a subject based upon static history data elements (e.g., a credit score, financial records, etc.).

Notably, however, these assessments may be performed only once (e.g., at one stage of policy underwriting), and may be made based upon stale or outdated information. Moreover, certain information may be inaccurate or incomplete. When an entity is making a decision based upon such an assessment (e.g., to purchase a home, insure a property, insure a person or household, etc.), these limitations may affect their decision-making ability or the ultimate outcome of their decision.

In the exemplary embodiment of the present disclosure, an object history or a subject history is developed by collecting (e.g., receiving, retrieving, etc.) data associated with the object/subject from a plurality of sources. These sources may include reference sources, such as insurance data sources, governmental data sources, and financial institutions. These reference sources may store data that is considered verified or validated, although this data may be static or relatively static (e.g., tax information, credit history, legal history, driving record, previous sale data, payment history, etc.).

The data sources may advantageously also include a plurality of sensors, which may provide more recent, current, updated, and/or real-time data associated with the object/subject (e.g., as distinct from more persistent data from the reference sources). The sensors may be vehicle sensors, device sensors (e.g., sensors within a user computing device operated by a user), home sensors, sensors within smart devices (e.g., “interne of things” devices), and the like.

In some instances, the TM computing device generates a first or initial history for the subject and/or object (generally, “subject history”) based upon the data from the reference sources. The TM computing device may thereafter update or replace the initial subject history with additional data—such as data from the plurality of sensors or any other data sources—to generate an updated subject history. The updated subject history may be referred to as a “real-time” or “current” subject history, in some exemplary embodiments, because this updated subject history may include the most recent available data associated with the subject (e.g., data retrieved and assessed within seconds, minutes, or hours of being sensed or captured). The TM computing device may update the subject history thereafter using any newly received data. In some embodiments, the TM computing device continuously updates the subject history, such as periodically (e.g., daily, weekly, monthly, quarterly, etc.) or in response to receiving new or updated data associated with a subject. In other embodiments, the TM computing device generates the updated subject history in response to a specific request. For example, a user may request an updated subject history because the user is initiating or updating an insurance policy, purchasing an object, selling an object, etc.

In the exemplary embodiment, the TM computing device stores the subject history/histories as a container file in an electronic ledger, to securely contain the information. The TM computing device generates an NFT for the subject based upon the data stored in the container file. The TM computing device allows subsequent access to the NFT by verified or authorized parties—such as a subject themselves, a user associated with the subject, a user purchasing an object, selling the object, insuring the object, etc. When new or updated information is received and/or incorporated into the container file, the TM computing device generates an updated NFT to represent the updated subject history. The updated NFT may be a completely new token, replacing any pre-existing token (while including a hash value of the previous token) or may be an updated version of the pre-existing token, with a hash including an update log or update history of the container file and/or NFT.

The TM computing device may be further configured to generate an assessment of the subject and/or object (generally, “subject assessment”) based upon the subject history—that is, an initial subject assessment as well as any number of updated (or current, real-time) subject assessments, which may replace or be appended to the initial subject assessment. In the exemplary embodiment, the subject assessment is an objective or quantitative assessment of the subject, such as the subject's reliability (or, in contrast, risk), an object's value, etc., depending upon the particular application of the present disclosure. In some embodiments, the TM computing device may be configured to execute a trained model to generate or calculate the subject assessment. The model may be trained using one or more machine learning, artificial intelligence, and/or cognitive computing techniques, using example reference and sensor data related to existing subjects/objects as training sets. By incorporating sensor data into the model training, the resulting output from the model—that is, the subject assessment—reflects a more complete, up to date, and comprehensive assessment and/or valuing of the subject.

In some embodiments, the TM computing device generates the NFT based on the subject history/histories, and subsequently retrieves the NFT (and the stored container file) to generate the subject assessment. That is, in some embodiments, the container file and/or NFT may not include the subject assessment but rather is a pointer to the data that can be readily retrieved for analysis to generate the subject assessment. In other embodiments, the TM computing device may store the subject assessment within a same container file, such that the NFT based upon the container file also includes the subject assessment.

The TM computing device may update the container file in response to receiving, retrieving, or assessing additional data. The TM computing device may, in some instances, update the subject history based upon the additional data, and update or overwrite the container file. The TM computing device may then re-execute the trained model using the updated container file. Where the model outputs a different subject assessment than the subject assessment stored in the container file, the TM computing device may update the subject assessment, which may include over-writing or otherwise replacing any pre-existing subject assessment with the new model output, or appending the new model output to the pre-existing subject assessment (e.g., as a new or most recent value in an array).

The NFT may therefore permit continuous, secured, and verified access to a subject's history/histories and assessment(s). Moreover, the NFT remains associated with the related subject or object regardless of any change in status or ownership thereof. That is, the NFT includes persistent information associated with a subject that is object-agnostic (e.g., associated only with the behavior/usage performed by the subject) or an object that is owner-agnostic. However, the NFT is also updated (by the TM computing device using the processes described herein) to reflect any changes in status of the subject. More particularly, the NFT will record any such status or ownership change.

In some instances, where an object is being insured, the object's history with a previous owner is recorded and reflected in the NFT, but the TM computing device may import and process data associated with a new or current owner to update the object's history and/or assessment. For example, a person is interested in purchasing and/or insuring a new vehicle or home. While that person's history may not affect the previous object assessment, factors associated with that person (e.g., a driving history, credit history, claim history, etc.) may be incorporated into an updated object assessment, to reflect any potential or likely impact the person's ownership or use may have on the object's value, risk, and/or reliability. In this way, the history or assessment of an object can be “cross-subject”—that is, the history or assessment reflects usage of the object by multiple persons (subjects).

In another instance, where a person is being insured or is seeking coverage of an object, the person's history with previous objects is recorded and reflected in an NFT associated with that person, even when the person's object(s), such as their home/domicile or vehicle, changes. For example, a person's driving behavior may persist across vehicles they own or use. In this way, the history or assessment of the subject can be “cross-object”—that is, the history or assessment reflects usage of various objects or behavior across time/objects by a same subject.

In various embodiments, an object assessment or subject assessment may be referred to as a “reliability score” or “risk score.” In certain embodiments, the reliability score or risk score may be directed to a vehicle, a home, or personal articles, such as antiques, or to a behavior of a person or person(s) (e.g., driving behavior, behavior within a home as it relates to risk, travel behavior as it relates to risk, etc.).

The subject/object assessments described herein may be more accurate, precise, comprehensive, and current than other assessments or scores. Therefore, these subject assessments may facilitate increased user confidence (e.g., in buying, selling, or insuring objects; in insuring users or their objects/property; in lending to a person(s); etc.), as well as improved process speeds and efficiency, by incorporating the quantitative and automatically generated subject assessments described herein. The disclosed systems and methods employ a collective of data points from smart devices, technology, Internet of Things/Behaviors devices and appliances, as well as evidence from numerous reports generated for home/buildings, vehicles, and other objects, user behaviors, etc.

Moreover, advanced technology (e.g., cognitive computing, AI, and ML) is executed to generate and train models that output assessments, scores, or ratings that are easy to understand, in particular regarding relative insurance risk, to inform a decision about the reliability of a home or vehicle investment, or to inform a decision regarding other types of risk (e.g., relative to lending to a person, selling an object to or buying an object from a person, insuring a household including a person(s), etc.).

The TM computing device implements the methods described herein to “connect the dots” about the use, maintenance, and other history of objects (e.g., real property) as well as behaviors and usage profiles or patterns of people, with real, objective, verifiable evidence (including data from references sources as well as sensors). The gathering of all these data points and scores (including the reliability scores and risk scores, as well as the sensor data (e.g., smart vehicle sensor data, mobile device sensor data, smart home sensor data) detailed above), and storing them with an NFT in an electronic ledger (e.g., a blockchain) enables adding new reports to the NFT in real time (e.g., as a new hash on the blockchain specific to one unique property such as a car or home or to one subject/user or household/defined groups of subjects/users).

Notably, the NFTs described herein may be formatted and stored as a unique data structure, which stores standardized, secured (e.g., encrypted) data about an object (e.g., a house, vehicle, etc.) and/or a subject (e.g., a homeowner, property occupant, tenant, vehicle owner, vehicle user, ride share driver or occupant, etc.), the cross-object ownership/usage history associated with a subject, and/or the cross-subject ownership/usage history of an object, in a readily retrievable format that enhances the efficiency, security, and reliability of subject and object assessment systems. In some instances, the NFT also stores the subject assessments, and/or other reports or records associated with an object and/or subject, for secure access by authorized parties without requiring any intermediate entity.

A brief discussion of examples and use cases follows herein. It should be readily understood that these examples and use cases are illustrative, and should not be taken to limit the present disclosure.

Examples of data that may incorporated into an object history and/or object assessment may include, but is not limited to: physical inspections, repair/maintenance history, external reports (e.g., police reports), purchase/sale history, permit history, claim history, tax history, location-related data (e.g., location risk data), and sensor data. As described herein, sensor data includes, but is not limited to, data from sensors in vehicles, user computing devices, homes/buildings, smart devices, smart materials, and “internet of things” devices and appliances, including smart thermostats that may sense temperature, humidity, and heating/cooling data. Sensor data may, in many cases, reflect the behavior and routines of one or more user(s) associated with an object. In the exemplary embodiment, one or more users associated with an object may provide permission or consent to the TM computing device to retrieve/receive/process certain data, and may revoke or change permissions for various data sources.

With respect to vehicles, if a young or unreliable driver repeatedly races a vehicle, but the vehicle remains looking pristine on the surface, the TM computing device may determine—based upon sensor data from the vehicle—that the engine and transmission has been used in a manner that could cause a shortened vehicle life span. The resulting object assessment may therefore reflect a higher risk, lower reliability, or lower value for the vehicle. Certain factors (e.g., sensor data) that may be assessed include acceleration data, braking data, cornering data, mileage, tire condition, maintenance or repair histories, vehicle part status, recall history or status, and the like.

With respect to buildings, a lack of maintenance records or permits, or data about home health, humidity, heating, cooling, and insurance claims could suggest a lower value, lower reliability, and/or higher risk for a building, which may be reflected in the resulting object assessment(s). For example, “DIY” repairs, keeping a home at an undesirable temperature or humidity, repeated insurance claims, and/or buildings in high risk locations may each be reflected in the object assessment(s). In contrast, records reflecting proper permitting for projects, the use of improved materials, and the like, could reflect more positively in the object assessment(s). Certain factors that may be assessed include inspection data, building materials, geographic location, addition/modification history, neighborhood risk factors, temperature data, humidity data, water data (e.g., sensed leaks), and insurance claims history.

A person's behavioral history, as represented by sensor data captured over time as well as certain records (e.g., credit records, financial records, legal records, etc.) may be aggregated and analyzed as part of their subject history and/or subject assessment. For example, driving behaviors may be included, such as acceleration data, braking data, cornering data, location data, routes, times of travel, and the like. In some instance, other travelling behaviors may be included to assess a person's behavior and relative risk, such as when the person is a passenger in vehicles or is travelling using a bike or scooter or as a pedestrian. Other behaviors may also be analyzed to assess a person's relative risk, like their behaviors at home that can be sensed using smart home, IoT, or home security devices, for example. For instance, a person's behavior related to leaving doors/windows locked or unlocked, leaving appliances on when not in use, smoke detector records, time at home vs. time away from home, and the like, can be representative of a person's behavior.

As discussed herein, an object's history/assessment can be cross-subject. For example, where a vehicle is a family vehicle used by several members of a household, each person's driving behavior in the vehicle may contribute to the vehicle's history/assessment. As another example, the history and/or assessment of a home or apartment with several occupants may be influenced by the behavior of all such occupants. Additionally, a subject's history and assessment can be cross-object. For example, a person's driving behavior across two or more vehicles can all contribute to that person's subject history/assessment. Similarly, the person's behavior while living at different addresses and/or while travelling can all contribute to the person's subject history/assessment.

In some exemplary embodiments, the TM computing device is programmed to weight behaviors or other factors differently. For example, behaviors may become “de-weighted” over time—such that a teenager whose driving behavior improves over time may have their subject assessment adjusted over time, as early driving behaviors impact their assessment less. As another example, a person who moves or changes jobs may drive or commute at less risky times or in less risky environments. In such a case, the risk level of their previous behavior becomes less impactful over time, relative to their subject assessment. The passage of time may be applied as a type of decay factor in the generation of assessments. Additionally or alternatively, major events may have a more drastic impact on the weighting of previous behaviors, such as moving, changing jobs, marriage, divorce, new children, children leaving a household, major illness, etc.

As described herein, for at least data security and transportability purposes, the TM computing device may “package” the subject histories and assessments as NFTs. In some examples, an NFT records a subject/object history and/or assessment relative to a single subject or object, which may be identified with a unique subject or object identifier, as described herein. In some additional embodiments, the TM computing device may be further programmed to generate NFTs that aggregate cross-subject object histories/assessments, cross-object subject histories/assessments, multiple subject histories/assessments, and/or multiple object histories/assessments, according to other rules that enable such grouping within a single NFT, referred to generally as a supertoken. For example, the TM computing device may be programmed to generate a supertoken representative of one household, which can include an aggregation of or pointers to individual NFTs for multiple household subjects, including occupants, the home/property, one or more vehicles, and/or other insured objects. As another example, the TM computing device may be programmed to generate a supertoken for a single vehicle that incorporates or points to the subject assessments of multiple drivers that use that vehicle as well as an NFT of the vehicle history itself. In such embodiments, the TM computing device may be further programmed to disaggregate such supertokens as required or requested. For example, where a child leaves a household, the TM computing device may be programmed to remove a subject assessment (or a pointer thereto) from a supertoken associated with that household or a vehicle used by members of the household.

In some embodiments, the TM computing device may transmit subject histories, subject assessments, object histories, object assessments, container files, and/or associated NFTs to (verified or validated) requesting parties. For example, the TM computing device may transmit an NFT for an object to an insurance underwriter, which enables the underwriter to access the object assessment. Insurance underwriting models and pricing can be developed and used based upon these subject and/or object assessments. Moreover, as subject histories and assessments are updated, this information can be processed and analyzed (e.g., by the TM computing device) to identify trends across like subjects, like objects, like locations, etc.

It should be understood that references to insurance products and policies herein are non-limiting references. In particular, policies may be issued for specific objects or groups thereof (e.g., one vehicle or a group/fleet of vehicles) and/or for specific individuals or groups thereof (e.g., policies covering a person and/or their partner(s), dependent(s), and/or household). That is, policies may be object- or subject-centered. In some instances, policies or other insurance products mat include usage-based insurance (UBI). UBI, as used herein, may refer generally to insurance policies based upon a user's particular usage or performance of one or more covered behaviors. For example, a usage-based policy associated with a user's travel may have certain charges or premiums associated with various types of travel (e.g., personal auto travel, public transportation, ride-sharing, biking, etc.). The cost of the policy may depend on how much the user uses each of those types of travel within a given time period (e.g., per month, per year, etc.).

“Personal mobility (PM) insurance” or “personal mobility policy (PMP),” as used herein, may refer generally to insurance policies based upon a user's usage of various forms of transportation. As increasingly more personal mobility options (e.g., modes of transportation) become available, users have more options to choose from when it comes to travel. Personal mobility insurance may provide coverage when a user is a pedestrian, a passenger of a ride-sharing service, and/or a driver of a rental vehicle, a semi-autonomous vehicle, and/or an autonomous vehicle. In other cases, personal mobility insurance may provide a user with coverage when the user rides a bike or an electric scooter. Personal mobility insurance further provides coverage in cases where a user may not own a vehicle and/or not drive. For example, the user may travel from place to place by using various alternative forms of transportation, including walking, biking, using public transportation, and/or using ride-sharing services. In these cases, personal mobility insurance may offer coverage if the user is injured as (i) a ride-share service passenger due to the driver's negligence or fault, (ii) a pedestrian getting into or out of a ride-share vehicle, and/or (iii) a bike or electric scooter rider due to being injured by an uninsured motorist.

Additionally, the present embodiments may relate to micro-mobility or micro mobility trends. For instance, the PMP or other insurance policies may cover micro-mobility forms of transformation and/or provide micro-mobility coverage on demand. The present embodiments may provide micro-mobility coverage or micro-mobility insurance for short distance travel—such as the first mile of a trip (such as to reach or travel to a public transportation or a ride share pick-up point), or the last mile of the trip (such as to reach or travel to a final destination, such as via e-scooter or bike). In some embodiments, the micro-mobility coverage or insurance may be in the form of UBI. UBI micro-mobility coverage may be sold by time or mileages, or other units (e.g., rides, trips), for instance. In one embodiment, the micro-mobility coverage may cover modes of transportation and/or vehicles with speeds less than 20 mph, carry 1 or 2 people, and associated with trips of short distances (such as a 1 or 2 miles).

“On-demand insurance,” as used herein, may refer generally to providing PMP (personal mobility policy) and/or micro-mobility UBI (usage-based insurance) quotes to a user in real time when coverage is requested by a user. On-demand insurance may provide coverage on a pay-as-you-go basis for each trip taken by the user (e.g., insurance provided on a trip-by-trip basis), as opposed to paying for coverage for a standard period of time (e.g., six months). For example, coverage may be requested or purchased for certain trips a user plans to take. PMP and/or micro-mobility insurance may be offered in various units, such as miles, time units, or rides. Micro-mobility insurance may cover short trips, such as the first mile and/or the last mile to a destination. For instance, the first mile and/or last mile to a destination may include users traveling by alternate forms of transportation, such as public transportation, ride shares, bicycles, or e-scooters.

In the exemplary embodiment, the TM computing device securely stores subject histories and assessments in container files that are accessible via cloud-based networks and devices, for improved accessibility.

As used herein, an NFT (non-fungible token) is a digital asset that represents another object, such as, but not limited to, a real-world object and/or a digital object. The NFT may be generally stored in a blockchain or other cryptographic ledger or register. The NFT may include, but is not limited to, ownership information and a link to a digital asset file that describes, points to, or otherwise indicates a real-world or digital object (or in some cases the NFT may actually include the data associated with the digital asset or real-world asset). NFTs may be traded, sold, exchanged, or otherwise change ownership. The ownership change may be stored on the corresponding blockchain, ledger, and/or register.

A blockchain is a distributed database that maintains a continuously-growing list of ordered records, known as blocks. Each block may contain at least a timestamp and a link to the previous block in the chain. The link to the previous block may be a hash of the previous block. For an insurance contract, the first block may contain the initial contract between a driver and an insurer. The second block may contain a modification to the contract that was requested by the driver and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

Other electronic ledger infrastructure may be employed, which may include blockchains or other similar technology. More broadly, the term “container file,” as used herein, may refer to a block in a blockchain, or to any other recorded instance in an immutable electronic ledger.

In at least one embodiment, the NFT entry on the blockchain includes the location of the NFT and a hash of the NFT. This hash allows the TM computing device and/or any users to ensure that the NFT has not been modified. In these embodiments, when data is added to the NFT, then the NFT is re-hashed, and that hash is provided in a new block on the blockchain. For example, the TM computing device may receive updated ownership information from a third-party server, or updated sensor information from a vehicle or user computing device. The TM computing device retrieves the location of the NFT and the hash for the NFT from the blockchain. The TM computing device compares the hash to the NFT to validate the NFT. In at least one embodiment, the TM computing device hashes the NFT and compares that hash to the stored hash. If they match, then the NFT is validated. The TM computing device modifies the NFT to include the report and then creates a hash of the NFT including the report. The new hash is reported to and stored in a new block on the blockchain.

At least one of the technical problems addressed by this system may include: (i) collecting and transforming reference and sensor data to generate subject and/or object histories; (ii) generating an NFT based upon a subject/object' s history to improve access security and standardize formatting of the subject/object history; (iii) generating such NFTs as unique data structures that can be encrypted—for increased data security—and subsequently decrypted—for access to the collected and transformed sensor data (e.g., as a standardized subject/object history) by permitted parties; (iv) enabling iteration of these processes with updated data to maintain currency of records; (v) improving speed and efficiency of insurance underwriting and the processing of requests for new or updated policies associated with subjects and/or objects; (vi) improving accuracy and reducing fraud (or buildup) related to object ownership transfer; (vii) ensuring the integrity of data related to an object's history and previous/current assessments; (viii) saving accurate records; (ix) consistently analyzing subject and object histories and assessments to provide consistent results and detect trends; (x) predicting potential issues based on these trends, to recommend mitigating action; (xi) allowing multiple users to interact with the data while preserving the data integrity; (xii) generating recommendations to improve subject/object assessments; (xiii) enabling the creation, storage, access, and use of cross-subject object histories and assessments, cross-objects subject histories and assessments, multiple-object histories and assessments, multiple-subject histories and assessments, and combinations and variations thereof; (xiv) transportable NFTs (including subject histories/assessments) that can be accessed and updated across applications and over time.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, mobile devices, wearables, AR or VR headsets or glasses, smart glasses, and/or other electrical or electronic components, wherein the technical effects may be achieved by performing at least one of the following steps: 1) receiving a plurality of data associated with an object history of an object; 2) generating a container file for the object history to include the plurality of data; 3) generating a non-fungible token (NFT) for the object based upon the container file; 4) storing the NFT and the container file for the object; 5) retrieving the NFT to access the plurality of data; and/or 6) inputting the plurality of data to a trained model to receive an initial object assessment as output from the trained model.

The technical effects may additional be achieved by performing at least one of the following steps: a) receiving a plurality of data associated with a subject history of a subject; b) generating a container file for the subject history to include the plurality of data; c) generating an NFT for the subject based upon the container file; d) storing the NFT and the container file for the subject; e) retrieving the NFT to access the plurality of data; and/or f) inputting the plurality of data to a trained model to receive an initial subject assessment as output from the trained model.

### Exemplary System and Process for NFT Generation and Maintenance

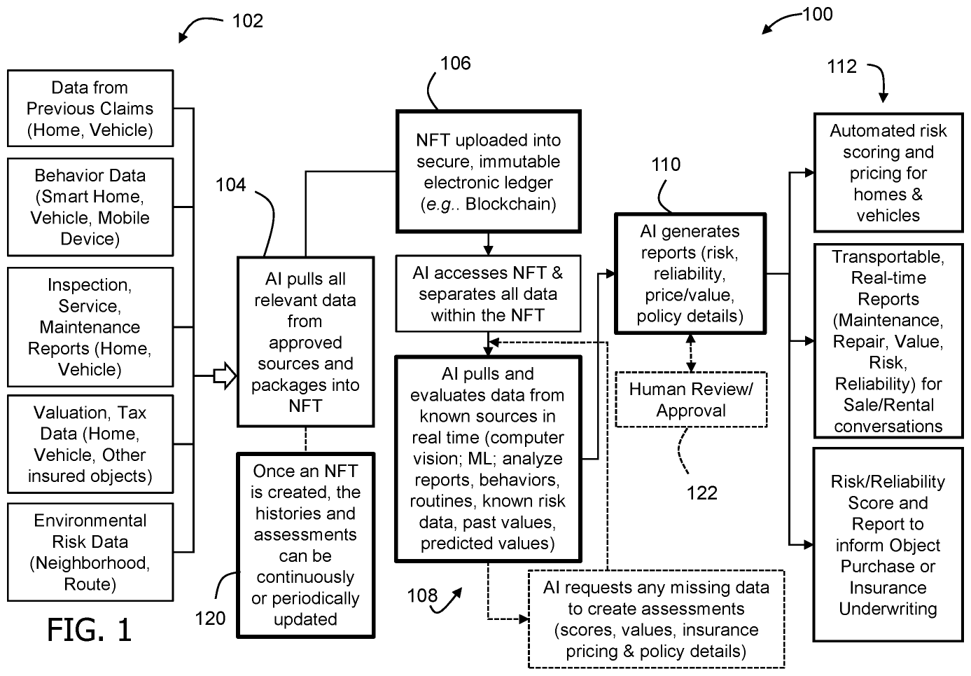

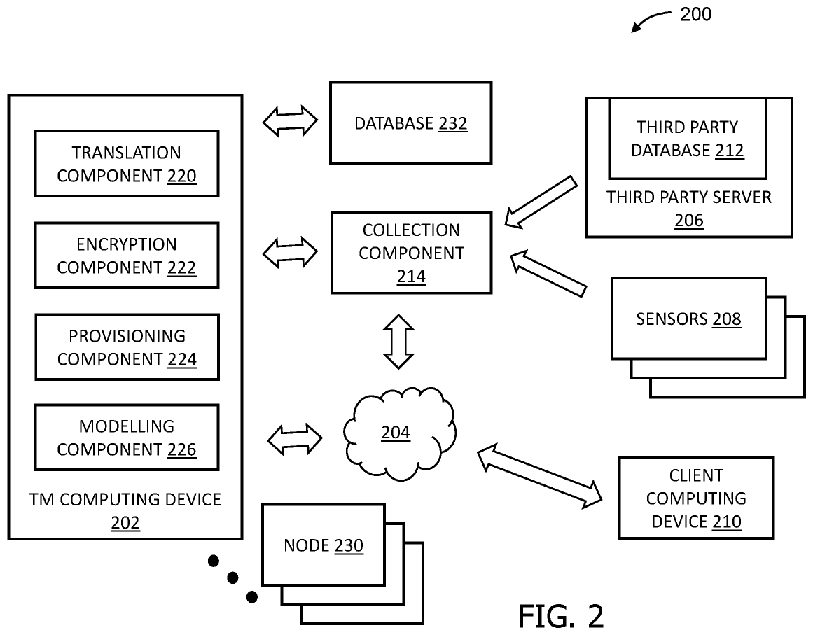

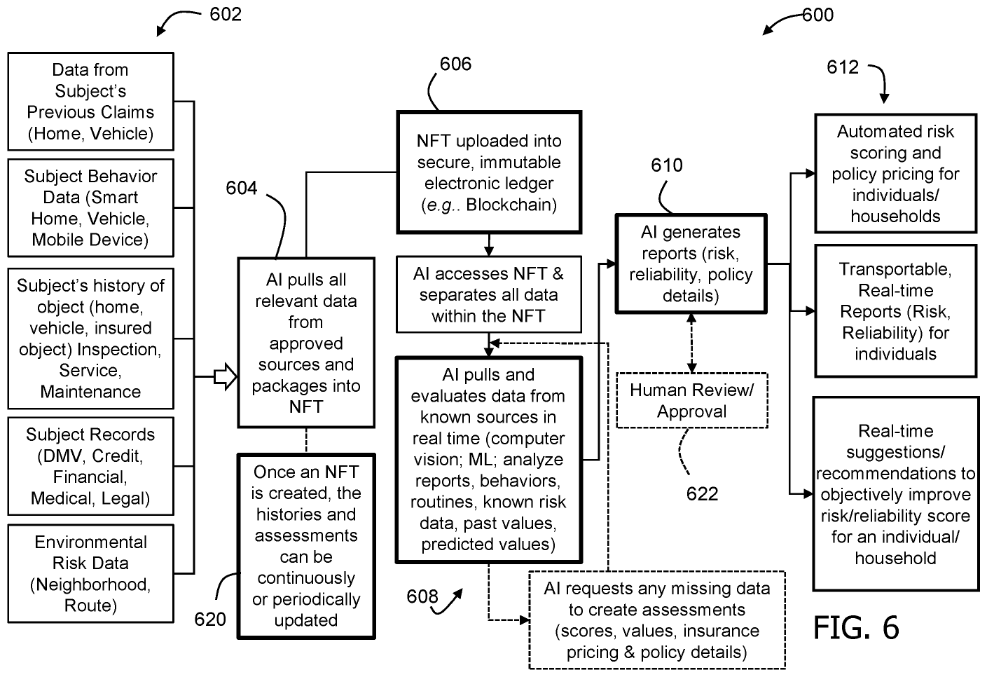

FIG. 1 illustrates a flow chart of an exemplary process 100 for generating and maintaining NFTs related to object histories and assessments in accordance with one embodiment of this disclosure. FIG. 6 illustrates a flow chart of an exemplary process 600 for generating and maintaining NFTs related to subject histories and assessments in accordance with one embodiment of this disclosure. FIG. 2 depicts a simplified block diagram of an exemplary computer system 200 for implementing process 100 shown in FIG. 1 and/or process 600 shown in FIG. 6. Concurrent reference to FIGS. 1, 2, and 6 may be made in the following discussions. Moreover, steps or functions that are similar between processes 100 and 600 may be referred to concurrently, using the reference numeral for a step in the process 100 (e.g., 102) and the reference numeral for a step in the process 600 (e.g., 602) simultaneously (e.g., “a step 102, 602”).

System 200 includes a token management (TM) computing device 202, also referred to as a TM server, which may perform one or more steps of processes 100 and 600. In the exemplary embodiment, TM computing device 210 includes one or more computers that include a web browser or a software application, which enables TM computing device(s) 202 to receive data and messages from other devices over a network 204 using the Internet.

In the exemplary embodiment, TM computing device 202 receives 102 a plurality of data associated with an object—more specifically, with an object history of the object. As shown in FIG. 1, such data may include, for example but without limitation, data from previous insurance claims related to the object or by a same or related insured, behavior/sensor data (e.g., from smart home devices, mobile devices, vehicles, etc.), reports associated with the object (e.g., inspection records, maintenance/service records, etc.), valuation and/or tax data associated with the object, and environmental data (e.g., weather data, risk data related to a location of the object, routes travelled using a vehicle, etc.).

With respect to FIG. 6, TM computing device receives 602 a plurality of data associated with a subject—more specifically, with a subject history of the subject. As explained herein, where the subject includes an object, the object history may be based upon some or all of the data described above. Where the subject includes a person, the data may additionally or alternatively include, without limitation, data from previous claims made by the subject, behavior data related to the subject, a history of the subject's reports and records related to insured objects, other records of the subject (e.g., governmental records such as driving records, credit records, financial records, legal records, medical records, etc.), and environmental data (e.g., where the subject is located, where the subject travels, risk profiles of the type, location, time of travel, etc.). As described herein, these subject histories can be cross-object. For example, if a person got a speeding ticket in one vehicle, that record applies to the subject regardless of what vehicle that person drives at other times.

As described herein, the data may be received 102, 602 from a plurality of sources and may include reference data (e.g., data that is relatively more static or persistent) and sensor data. In some instances, TM computing device 202 receives 102, 602 the data in response to a specific request. In other instances, TM computing device 202 receives 102, 602 data on a periodic or continuous basis.

As shown in FIG. 2, TM computing device 202 is configured to receive (102, 602) this plurality of data from a variety of sources, such as third-party servers 206, a plurality of sensors 208, and/or one or more client computing device 210. Third-party servers 206 may represent data sources that provide information—such as reference information—to TM computing device 202. For example, third-party servers 206 may be associated with insurance providers, governmental entities (e.g., law enforcement), financial institutions, repair or maintenance contracting parties, medical service providers, transportation service providers (e.g., vehicle sharing systems, public transportation systems, etc.) and/or other third parties. Third-party servers 206 each may be associated with a third-party database 212. Sensors 208 are devices capable of sensing attributes of their environment. Sensors 208 can be a part of an object being assessed (e.g., a vehicle, home, building) and/or can be disposed within a mobile device, and/or any other object that the sensors 208 can then provide the attributes of, as described herein.

In the exemplary embodiment, client computing devices 210 are computers that include a web browser or a software application, which enables client computing devices 210 to access TM computing device 202 via network 204 using the Internet. Client computing device 210 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, smart glasses, AR/VR devices, or other web-based connectable equipment or mobile devices. In some embodiments, client computing devices are capable of requesting and/or accessing information from or providing information to TM computing device 202 (e.g., providing reference information and/or sensor data; requesting container files; requesting NFTs, etc.). Client computing device 210 may be associated with a subject, a user of an object being assessed, or a user otherwise associated with the subject or object (e.g., buyer, seller, insurer, assessor).

System 200 also includes one or more collection component(s) 214. Collection components 214 can include one or more client-side devices, and/or one or more server-side device(s). Collection components 214 can be embodied as standalone computing devices or servers configured to receive and package (e.g., collect) information from any of third-party servers 206, sensors 208, and client computing device 210, directly and/or indirectly (e.g., via network 204). In particular, collection components 214 may be continuously or periodically receiving information (about subjects and/or objects) from a variety of sources, as described herein. Collection components 214 may compile and parse or partition this received data, such that data associated with one subject, one object, one subject and one object, one subject across multiple objects, and/or one object across multiple subjects is collected and available. For example, collection components 214 may process and index any received data based on a subject identifier or an object identifier (e.g. an alphanumeric identifier uniquely associated with a subject or object), for retrieval by TM computing device 202. It should also be understood that collection component 214 may process and compile data that is related or applicable to more than one subject, more than one object, and/or a subject(s) and object(s) simultaneously.

In some instances, this indexing or cataloging function may involve significant processing to determine that data received from disparate sources is, in fact, associated with one common subject and/or object. This processing may include any suitable text- or image-based processing, location processing or geo-locating, and the like, and may involve one or more machine-learning or artificial intelligence techniques. Although collection component 214 is shown as a separate device in FIG. 2, it should be understood that in some embodiments, collection component 214 may be implemented as an executable module or separate processing component of TM computing device 202, without departing from the scope of the present disclosure.

TM computing device 202 receives the packaged or indexed data from collection component 214 and generates 104 at least one NFT based on the received (102, 602) data. In particular, as described herein, TM computing device 202 generates a container file including the data (e.g., as a subject history and/or an object history) and generates 104, 604 the NFT for the subject and/or object based upon the container file. It should also be understood that TM computing device 202 may receive packaged or indexed data from collection component 214 that is related or applicable to more than one subject, more than one object, and/or a subject(s) and object(s) simultaneously. In such cases, TM computing device 202 may generate one more corresponding NFTs and/or one or more related supertokens including aggregations and/or pointers to the NFTs forming the supertokens.

In one exemplary embodiment, as shown in FIG. 2, TM computing device 202 includes a plurality of components, including a translation component 220, an encryption component 222, a provisioning component 224, and a modelling component 226. These components may be representations of specialized programming and/or computer-executable code executed by one or more processing components of TM computing device 202.

To generate 104, 604 the NFT based upon the received (102, 602) data, in some embodiments, TM computing device 202 executes or initializes translation component 220 thereof. Translation component 220 may be programmed or configured to perform any necessary or useful translation of the received (102, 602) data. That is, translation component 220 may translate or transform the received (102) data into an object history for an object and/or may translate or transform the received (602) data into a subject history for a subject. Translation component 220 may perform various processing on the received (102, 602) data, such as re-formatting, standardization, parsing, re-sizing, and the like, to generate the history for the object or subject. It should also be understood that translation component 220 may output translations of received (102, 602) data that is applicable to more than one subject, more than one object, and/or a subject(s) and object(s) simultaneously.

Subsequently, TM computing device 202 may execute or initialize encryption component 222 to encrypt the subject history and/or object history. More particularly, encryption component 222 may be configured or programmed to hash or otherwise encrypt the subject history and/or object history to generate the container file and, thereafter, generate 104, 604 the encrypted NFT based upon the container file.

TM computing device 202 stores 106, 606 the container file and NFT in a cloud-based electronic ledger (e.g., a blockchain) for secure, immutable storage. In some embodiments, TM computing device 202 may execute or initialize provisioning component 224 to store 106, 606 the container file and NFT. More specifically, provisioning component 224 may push or transmit container files and/or NFTs to other node devices 230 that maintain the electronic ledger. Provisioning component 224 may additionally store the container files and/or NFTs on any other cloud-based storage device, such as one or more databases 232. Moreover, provisioning component 224 may be configured or programmed to push any updates to container files and/or NFTs to node devices 230, in response to any updates as described herein.

TM computing device 202 accesses 108 the NFT and associated container file to perform the various more artificial intelligence (AI), machine learning (ML), and/or cognitive computing functions techniques described herein, to analyze the stored data and identify, for example, behaviors, routines, risks, and past values, as well as to predict affects and/or future values based upon that stored data. In one exemplary embodiment, TM computing device 202 executes or initializes modelling component 226 to perform these analyses. Modelling component 226 may be configured or programmed to train one or more models and/or execute such trained models to analyze subject histories and/or object histories and output associated subject assessments and/or object assessments. In some embodiments, TM computing device 202 determines that one or more data elements are missing, where such data elements are important in the assessment of a subject and/or an object. In such cases, TM computing device 202 may communicate with one or more data sources (e.g., via network 204) to retrieve and access such missing data.

Modelling component 226 may also include such trained models that are pre-programmed to assign weighting factors and/or decay factors to certain input data, such as factors relating to a time associated with the input data (e.g., how much time has elapsed since the data was captured) or factors relating to a major change associated with the subject/object.

Based upon these executed one or more AI, ML, and/or cognitive computing functions, TM computing device 202 (e.g., via modelling component 226) calculates or generates 110, 610 one or more subject assessment(s) for the subject(s) and/or one or more object assessment(s) for the object(s). In one or more embodiments, TM computing device 202 generates 110, 610 the subject/object assessment(s) including a corresponding risk/reliability/value score or metric, as a quantitative assessment of the subject/object(s) based upon the reference and sensor data. TM computing device 202 may additionally generate 110, 610 one or more reports or other records associated with the subject/object(s) and/or the subject/object assessment(s). TM computing device 202 may then provide 112, 612 the subject assessment(s) and/or object assessment(s) and any reports/records within one or more messages to a user associated with the subject(s) or object(s) (e.g., a seller, buyer, insurance underwriter, etc.). TM computing device 202, advantageously, may maintain and provide 112, 612 those assessments (e.g., as NFTs) over time, even when a person changes insurance companies or has other major life events. TM computing device 202 may additionally or alternatively provide 112, 612 recommendations to one or more persons to improve an associated subject/object assessment. For example, TM computing device 202 may provide 112, 612 a recommendation that a person schedule more frequent or consistent maintenance on a vehicle to improve the object assessment associated with the vehicle. As another example, TM computing device 202 may provide 612 a recommendation that a person travel at less risky times or reduce their speed of driving, to improve a subject assessment of that person (e.g., which may, in turn, reduce an insurance premium paid by that person).

In some embodiments, processes 100, 600 also include updating 120, 620 the data stored in the container file and/or the NFT. Updating 120, 620 may be conducted in response to a request for a report/assessment, in response to receiving 102, 602 updated data, periodically, and/or under any other appropriate condition. In some embodiments, processes 100, 600 may also include a manual or human review 122, 622 of any functions performed by and/or outputs from TM computing device 202.

Turning to FIG. 2 for further explanation of system 200, TM computing device 202 is in communication with plurality of sensors 208. In particular, TM computing device 202 receives sensor data from sensors 208, for further processing to generate and maintain subject histories and assessments, as described herein. Sensors 208 may include, but are not limited to, vehicle sensors, home sensors, infrastructure sensors, sensors in one or more mobile devices, and/or any other type of sensor that may be used to analyze an event, object, environment, behavior, etc.

Vehicle-based sensors may include navigation, communications, safety, security, and/or “infotainment” data. For example, vehicle telematics data collected may include, but is not limited to braking and/or acceleration data, navigation data, vehicle settings (e.g., seat position, minor position, temperature, or air control settings, etc.), remote-unlock and/or remote-start data (e.g., determining which user computer device is used to unlock or start vehicle) and/or any other telematics data. Sensors 208 may also include sensors that detect conditions of vehicle, such as covered distance, speed, acceleration, gear, braking, and other conditions related to the operation of vehicle, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 208 may include impact sensors that detect impacts to vehicle, including force and direction and sensors that detect actions of vehicle, such the deployment of airbags. In some embodiments, plurality of sensors 208 may detect the presence of driver and one or more passengers (not shown) in vehicle. In these embodiments, plurality of sensors 208 may detect the presence of fastened seatbelts, the weight in each seat in vehicle, heat signatures, or any other method of detecting information about driver and/or passengers in vehicle.

In the case of property, such as, but not limited to, a home and/or a business property, sensors 208 may be deployed (and/or embedded) throughout property. Sensors 208 may include, broadly, any kind of sensor (e.g., temperature, humidity, motion, sound/audio signal, light, etc.). In some embodiments, sensors 208 specifically include a smart thermostat. Sensors 208 may be part of a smart home system or one or more “Internet of Things” devices or appliances, such as smart locks, furnaces, air conditioners, thermostats, light bulbs, appliances, sensors, and any other device or processor, which may be connected through a centralized smart home hub. The smart home system may include a home security system which may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the structure on the property, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that may detect potential contemporaneous risks to the property or its occupants (e.g., intrusion, fire, health).

Additional sensors 208 may include subject sensors, such as sensors within mobile devices carried and operated by a person (subject), wearable devices worn by a person, pairing or connectivity data of devices operated by the person, location data, and the like.

In the exemplary embodiment, sensors 208 are enabled to transmit sensor data to TM computing device 202 using the Internet. More specifically, sensors 208 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In some embodiments, sensors 208 may be associated with any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bot, smart glasses, AR/VR device, or other web-based connectable equipment or mobile devices.

In the exemplary embodiment, third-party servers 206 are computers that include a web browser or a software application, which enables third-party servers 206 to access TM computing device 202 using the Internet, as described herein. Third-party servers 206 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, chat bots, or other web-based connectable equipment or mobile devices.

In some embodiments, database 232 may store sensor data, reference data, container files, NFTs, blockchains, ownership information, preferences provided by a policyholder or other user, subject histories, subject assessments, object histories, object assessments, and/or any other data described herein. In the exemplary embodiment, database 232 may be stored remotely from TM computing device 202. In some embodiments, database 232 may be decentralized. In the exemplary embodiment, a person may access database 232 by logging onto TM computing device 202, as described herein (e.g., via a client computing device 210).

Node computing device 230 may be similar to TM computing device 202, client computing devices 210, and/or third party servers 206. Broadly, node devices 230 may be any computer device capable of maintaining an electronic ledger (e.g., a blockchain).

### Exemplary Computer-Implemented Methods for Generating and Maintaining Subject-Related and Object-Related NFTS

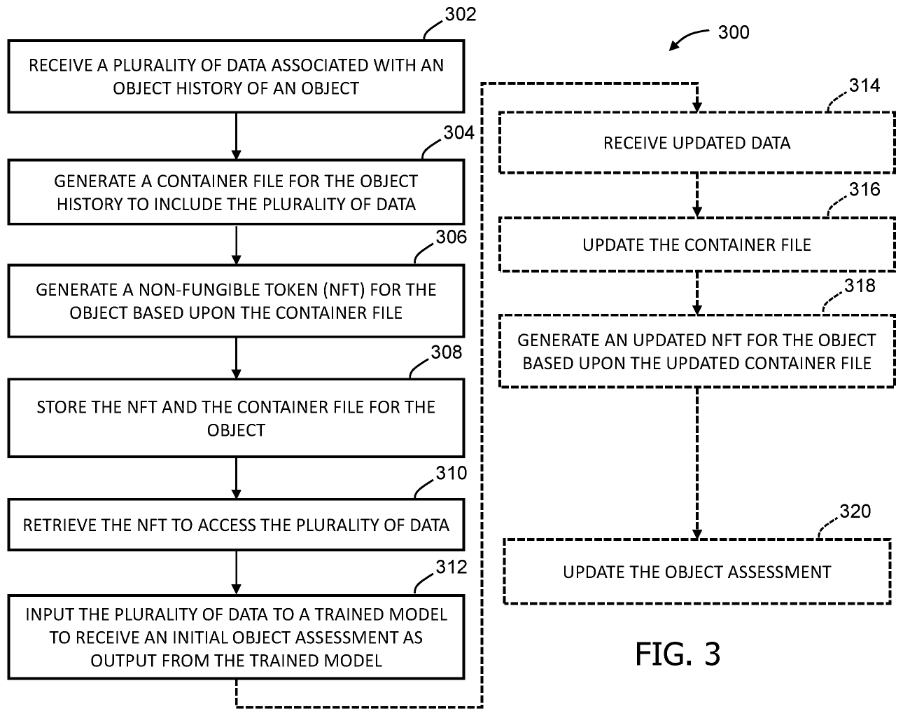

FIG. 3 illustrates a flow chart of an exemplary computer-implemented process 300 for generating and maintaining NFTs for object histories and assessments, using the system 200 (shown in FIG. 2).

Process 300 may be implemented by a computing device, for example TM computing device 202 (shown in FIG. 2). In the exemplary embodiment, TM computing device 202 receives 302 a plurality of data associated with an object history of an object, generates 304 a container file for the object history to include the plurality of data, and generates 306 a non-fungible token (NFT) for the object based upon the container file. TM computing device 202 also stores 308 the NFT and the container file for the object, retrieves 310 the NFT to access the plurality of data, and inputs 312 the plurality of data to a trained model to receive an initial object assessment as output from the trained model.

In some embodiments, process 300 also includes receiving 314 updated data associated with the history of the object, updating 316 the stored container file with the updated data, generating 318 an updated NFT for the object based upon the updated container file, and updating 320 the object assessment based on the updated NFT and/or updated container file. These steps may be iterated periodically or continuously to maintain currency of the NFT and the associated object assessment.

Process 300 may include additional, fewer, and/or alternative steps. In some embodiments, the subject is an object to be insured, the subject assessment includes a reliability score related to a value of the object based upon previous usage of the object, and receiving 302 includes receiving the plurality of data corresponding to usage of the object by a plurality of persons. In some embodiments, process 300 further includes receiving (e.g., receiving 314) updated data associated with the object, the updated data indicating an ownership change of the object from a previous owner to a new owner, updating (e.g., updating 316) the container file with at least one of the updated data, updating (e.g., generating 318) the NFT based upon the updated container file, and causing the trained model to apply a decay factor to data associated with the previous owner of the object in generating subsequent subject assessments of the object.

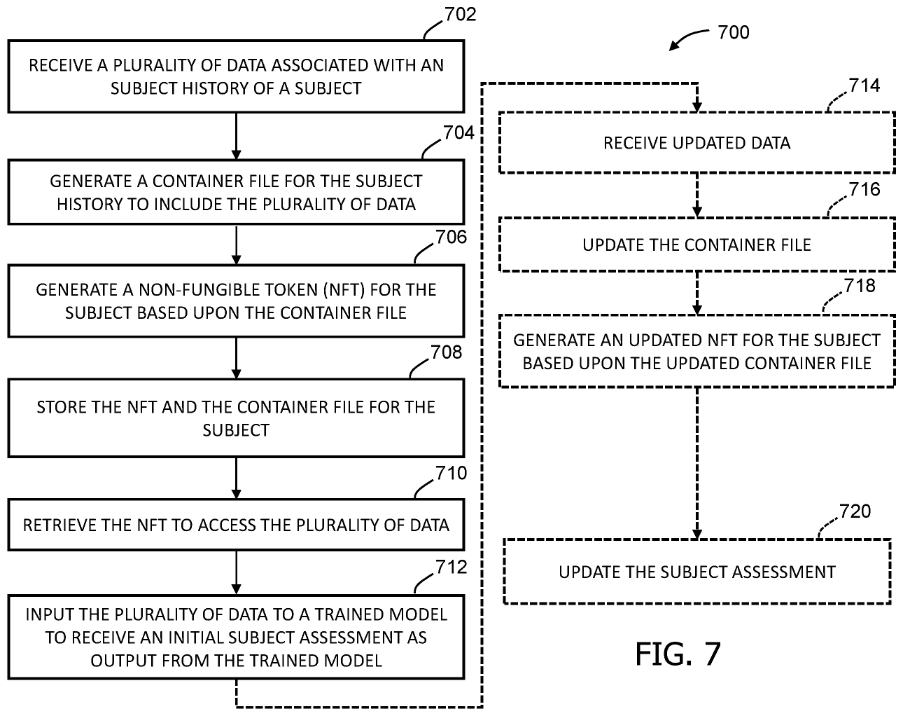

FIG. 7 illustrates a flow chart of an exemplary computer-implemented process 700 for generating and maintaining NFTs for subject histories and assessments, using the system 200 (shown in FIG. 2).

Process 700 may be implemented by a computing device, for example TM computing device 202 (also shown in FIG. 2). In the exemplary embodiment, TM computing device 202 receives 702 a plurality of data associated with a subject history of a subject, generates 704 a container file for the subject history to include the plurality of data, and generates 706 a non-fungible token (NFT) for the subject based upon the container file. TM computing device 202 also stores 708 the NFT and the container file for the subject, retrieves 710 the NFT to access the plurality of data, and inputs 712 the plurality of data to a trained model to receive an initial subject assessment as output from the trained model.

In some embodiments, process 700 also includes receiving 714 updated data associated with the history of the subject, updating 716 the stored container file with the updated data, generating 718 an updated NFT for the subject based upon the updated container file, and updating 720 the subject assessment based on the updated NFT and/or updated container file. These steps may be iterated periodically or continuously to maintain currency of the NFT and the associated subject assessment.

Process 700 may include additional, fewer, and/or alternative steps. In some embodiments, the subject is an individual person, and wherein the subject assessment includes a quantitative assessment of one or more behaviors of the person, and receiving 702 includes receiving the plurality of data corresponding to the one or more behaviors of the person during usage of multiple objects by the person.

### Exemplary User Computing Device

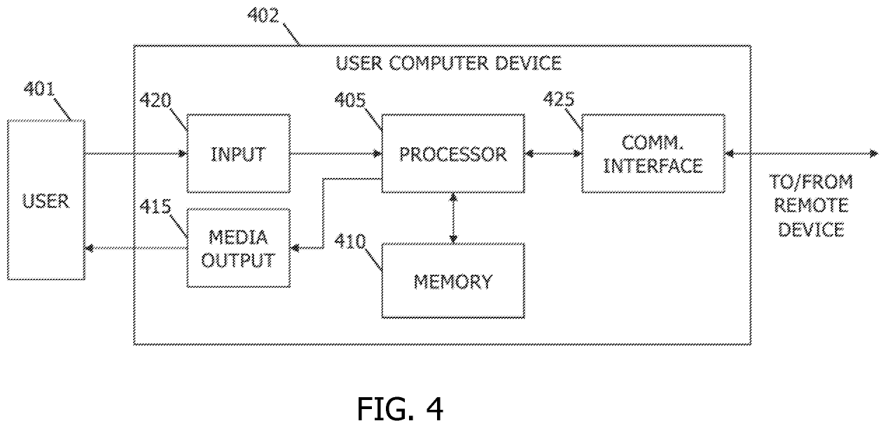

FIG. 4 depicts an exemplary configuration of a user computer device 402 that may be operated by a user 401. User computer device 402 may include, but is not limited to, third-party servers 206, sensors 208, client computer devices 210, collection component 214, and/or node devices 230 (all shown in FIG. 2). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 415 may be configured to present a graphical user interface (e.g., a web browser and/or a client application) to user 401. A graphical user interface may include, for example, an interface for displaying information from a container file. In some embodiments, user computer device 402 may include an input device 420 for receiving input from user 401. User 401 may use input device 420 to, without limitation, select and/or enter information for the container file. Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as the TM computing device 202 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from TM computing device 202. A client application allows user 401 to interact with, for example, TM computing device 202. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

### Exemplary Server Device

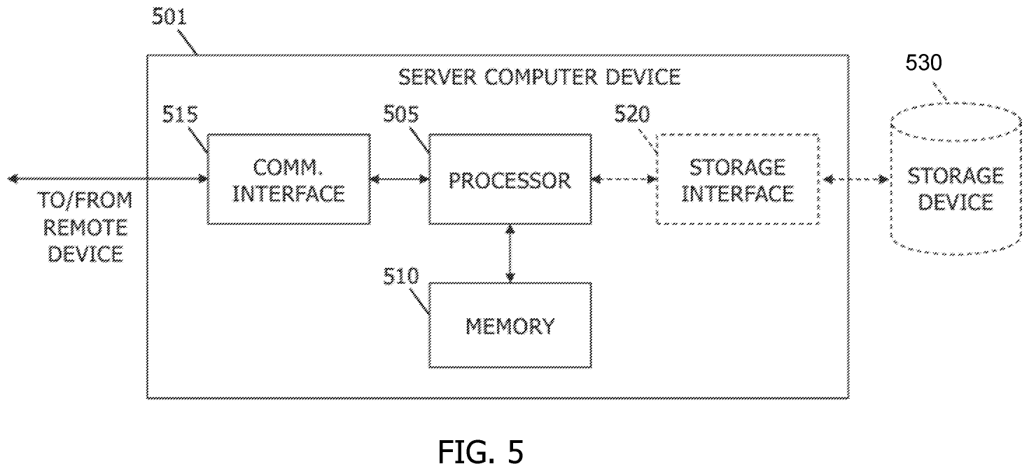

FIG. 5 depicts an exemplary configuration of server computer device 501, in accordance with one embodiment of the present disclosure. Server computer device 501 may include, but is not limited to, TM computing device 202, third-party server 206, collection component 214, and/or node devices 230 (all shown in FIG. 2). Server computer device 501 may include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, node devices 230, sensors 208, or client computer devices 210 (shown in FIG. 2). For example, communication interface 515 may receive messages from client computer devices 210 via the Internet, as illustrated in FIG. 2.

Processor 505 may also be operatively coupled to a storage device 530. Storage device 530 may be any computer-operated hardware suitable for storing and/or retrieving data, such as, but not limited to, data associated with database 232 or third-party database 212 (shown in FIG. 2). In some embodiments, storage device 530 may be integrated in server computer device 501. For example, server computer device 501 may include one or more hard disk drives as storage device 530. In other embodiments, storage device 530 may be external to server computer device 501 and may be accessed by a plurality of server computer devices 501. For example, storage device 530 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 530 via a storage interface 520. Storage interface 520 may be any component capable of providing processor 505 with access to storage device 530. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 530.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIGS. 1 and 3.

### Exemplary Embodiments & Functionality

In another embodiment, a computer system for generating and maintaining object assessments may be provided. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may (i) receive a plurality of data associated with an object history of an object; (ii) generate a container file for the object history to include the plurality of data; (iii) generate a non-fungible token (NFT) for the object based upon the container file; (iv) store the NFT and the container file for the object; (v) retrieve the NFT to access the plurality of data; and/or (vi) input the plurality of data to a trained model to receive an initial object assessment as output from the trained model. The computer system may be configured with additional, less, or alternate functionality, including that discussed elsewhere herein.

In another embodiment, a computer system for generating and maintaining subject and object assessments may be provided. The computer system may include one or more local or remote processors, sensors, transceivers, servers, memory units, mobile devices, augmented reality glasses or headsets, extended or virtual reality headsets, smart glasses or watches, wearables, and/or other electronic or electrical components. In one instance, the computer system may (i) receive a plurality of data associated with a subject history of a subject; (ii) generate a container file for the subject history to include the plurality of data; (iii) generate a non-fungible token (NFT) for the subject based upon the container file; (iv) store the NFT and the container file for the subject; (v) retrieve the NFT to access the plurality of data; and/or (vi) input the plurality of data to a trained model to receive an initial subject assessment as output from the trained model. The computer system may be configured with additional, less, or alternate functionality, including that discussed elsewhere herein.

For instance, in some enhancements, the plurality of data includes reference data and sensor data. In some cases, the plurality of data includes sensor data received from sensors disposed within an object being assessed. In some cases, wherein the plurality of data includes sensor data received from sensors disposed within a user computing device operated by the subject.

In some further enhancements, at least one processor is further programmed to: (vii) receive updated data associated with the subject and/or object; (viii) update the container file with at least one of the updated data; and/or (ix) update the NFT based upon the updated container file. In some cases, at least one processor is further programmed to: (x) re-execute the trained model with the updated data; and/or (xi) receive an updated subject and/or object assessment as output from the trained model.

In some enhancements, the subject is an object to be insured, and the at least one processor is further programmed to apply the object assessment to an insurance underwriting process to generate an insurance policy associated with the object.

In some additional enhancements, at least one processor is further programmed to: (a) generate a hash of the container file; and/or (b) store the hash of the container file in the NFT. In some cases, at least one processor is further programmed to: (c) receive additional data for the container file; (d) update the container file with the additional data; (e) generate an updated hash for the updated container file; and/or (f) store the updated hash in the NFT. In some instances, at least one processor is further programmed to: (g) store the updated container file as a new file; and/or (h) link the NFT to the new file. In other cases, at least one processor is further programmed to: (i) retrieve the container file based on the NFT; (j) generate a validation hash of the container file; and/or (k) validate the container file based on the validation hash matching the hash stored in the NFT.

In some enhancements, the subject is an object to be insured, and the subject assessment includes a reliability score related to a value of the object based upon previous usage of the object. In some instances, the at least one processor is further programmed to receive the plurality of data corresponding to usage of the object by a plurality of persons. In some further instances, the at least one processor is further programmed to: (a) receive updated data associated with the object, the updated data indicating an ownership change of the object from a previous owner to a new owner; (b) update the container file with at least one of the updated data: and/or (c) update the NET based upon the updated container file. In some still further enhancements, the at least one processor is further programmed to cause the trained model to apply a decay factor to data associated with the previous owner of the object in generating subsequent subject assessments of the object.

In additional enhancements, the subject is an individual person, and wherein the subject assessment includes a quantitative assessment of one or more behaviors of the person. In some instances, the at least one processor is further programmed to receive the plurality of data corresponding to the one or more behaviors of the person during usage of multiple objects by the person. In some enhancements, the at least one processor is further programmed to: (a) receive updated data associated with the subject, the updated data indicating an acquisition of a new object by the person; (b) update the container file with at least one of the updated data; and/or (c) update the NFT based upon the updated container file. In some further enhancements, the at least one processor is further programmed to input the updated data into the trained model to generate an updated subject assessment that incorporates data associated with the new object and usage thereof by the person.

In another aspect, a computer-implemented method may provide enhanced object assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (1) receiving, via one or more processors and/or associated transceivers, a plurality of data associated with an object history of an object; (2) generating, via the one or more processors, a container file for the object history to include the plurality of data; (3) generating, via the one or more processors, a non-fungible token (NFT) for the object based upon the container file; (4) storing, via the one or more processors, the NFT and the container file for the object; (5) retrieving, via the one or more processors, the NFT to access the plurality of data; and/or (6) inputting, via the one or more processors, the plurality of data to a trained model to receive an initial object assessment as output from the trained model. The method may include additional, less, or alternate actions, including those discussed elsewhere herein.

In another aspect, a computer-implemented method may provide enhanced subject assessment using automated NFT generating and maintenance. The method may be implemented via one or more local or remote processors, sensors, transceivers, servers, memory units, mobile devices, augmented reality glasses or headsets, extended or virtual reality headsets, smart glasses or watches, wearables, and/or other electronic or electrical components. In one instance, the method may include: (1) receiving, via one or more processors and/or associated transceivers, a plurality of data associated with a subject history of a subject; (2) generating, via the one or more processors, a container file for the object history to include the plurality of data; (3) generating, via the one or more processors, a non-fungible token (NFT) for the subject based upon the container file; (4) storing, via the one or more processors, the NFT and the container file for the subject; (5) retrieving, via the one or more processors, the NFT to access the plurality of data; and/or (6) inputting, via the one or more processors, the plurality of data to a trained model to receive an initial subject assessment as output from the trained model. The method may include additional, less, or alternate actions, including those discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, in homes, as part of an “internet of things” architecture, or otherwise associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as (but not limited to) reference data, sensor data, mobile device data, vehicle telematics data, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of persons, belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing reference data, sensor data, vehicle or home telematics data, image data, mobile device data, and/or other data.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system including at least one processor in communication with at least one memory device, the at least one processor programmed to:
receive a plurality of data associated with a subject history of a subject;
generate a container file for the subject history to include the plurality of data;
generate a non-fungible token (NFT) for the subject based upon the container file;
store the NFT and the container file for the subject;
retrieve the NFT to access the plurality of data; and
input the plurality of data to a trained model to receive an initial subject assessment as output from the trained model.

2. The computer system of claim 1, wherein the plurality of data includes historical reference data associated with the subject and sensor data captured by one or more sensors associated with the subject.

3. The computer system of claim 1, wherein the at least one processor is further programmed to:
receive updated data associated with the subject;
update the container file with at least one of the updated data; and
update the NFT based upon the updated container file.

4. The computer system of claim 3, wherein the at least one processor is further programmed to:
re-execute the trained model with the updated data; and
receive an updated subject assessment as output from the trained model.

5. The computer system of claim 1, wherein the subject is an object to be insured, and wherein the at least one processor is further programmed to apply the subject assessment to an insurance underwriting process to generate an insurance policy associated with the object.

6. The computer system of claim 1, wherein the subject is an object to be insured, and wherein the subject assessment includes a reliability score related to a value of the object based upon previous usage of the object.

7. The computer system of claim 6, wherein the at least one processor is further programmed to receive the plurality of data corresponding to usage of the object by a plurality of persons.

8. The computer system of claim 7, wherein the at least one processor is further programmed to:
receive updated data associated with the object, the updated data indicating an ownership change of the object from a previous owner to a new owner;
update the container file with at least one of the updated data; and
update the NFT based upon the updated container file.

9. The computer system of claim 8, wherein the at least one processor is further programmed to cause the trained model to apply a decay factor to data associated with the previous owner of the object in generating subsequent subject assessments of the object.

10. The computer system of claim 1, wherein the plurality of data includes sensor data received from sensors disposed within a user computing device operated by the subject.

11. The computer system of claim 1, wherein the subject is an individual person, and wherein the subject assessment includes a quantitative assessment of one or more behaviors of the person.

12. The computer system of claim 11, wherein the at least one processor is further programmed to receive the plurality of data corresponding to the one or more behaviors of the person during usage of multiple objects by the person.

13. The computer system of claim 12, wherein the at least one processor is further programmed to:
receive updated data associated with the subject, the updated data indicating an acquisition of a new object by the person;
update the container file with at least one of the updated data; and
update the NFT based upon the updated container file.

14. The computer system of claim 13, wherein the at least one processor is further programmed to input the updated data into the trained model to generate an updated subject assessment that incorporates data associated with the new object and usage thereof by the person.

15. The computer system of claim 1, wherein the subject includes an object, and the plurality of data includes sensor data received from sensors disposed within the object.

16. A computer-implemented method, the method comprising:
receiving, via one or more processors and/or associated transceivers, a plurality of data associated with a subject history of a subject;
generating, via the one or more processors, a container file for the subject history to include the plurality of data;
generating, via the one or more processors, a non-fungible token (NFT) for the subject based upon the container file;
storing, via the one or more processors, the NFT and the container file for the subject;
retrieving, via the one or more processors, the NFT to access the plurality of data; and
inputting, via the one or more processors, the plurality of data to a trained model to receive an initial subject assessment as output from the trained model.

17. The computer-implemented method of claim 16, further comprising:
receiving updated data associated with the subject;
updating the container file with at least one of the updated data; and
updating the NFT based upon the updated container file.

18. The computer-implemented method of claim 16, wherein the subject is an object to be insured, and wherein the subject assessment includes a reliability score related to a value of the object based upon previous usage of the object, the receiving comprising receiving the plurality of data corresponding to usage of the object by a plurality of persons.

19. The computer-implemented method of claim 18, further comprising:
receiving updated data associated with the object, the updated data indicating an ownership change of the object from a previous owner to a new owner;
updating the container file with at least one of the updated data;
updating the NFT based upon the updated container file; and
causing the trained model to apply a decay factor to data associated with the previous owner of the object in generating subsequent subject assessments of the object.

20. The computer-implemented method of claim 16, wherein the subject is an individual person, and wherein the subject assessment includes a quantitative assessment of one or more behaviors of the person, the receiving comprising receiving the plurality of data corresponding to the one or more behaviors of the person during usage of multiple objects by the person.
